(19) United States
(12) Patent Application Publication
(10) Pub. No.: US 2025/0074604 A1
(43) Pub. Date: Mar. 6, 2025

(54) ASCERTAINING A FLIGHT STATE, AND CONTROLLING A PARAGLIDER

(71) Applicant: ATLASAERO GmbH, Feldkirchen-Westerham (DE)

(72) Inventors: Jürgen STÄDTLER, Feldkirchen-Westerham (DE); Marius MEIßNER, Brannenburg (DE)

(73) Assignee: ATLASAERO GmbH, Feldkirchen-Westerham (DE)

(21) Appl. No.: 18/559,849

(22) PCT Filed: May 11, 2021
(86) PCT No.: PCT/EP2021/062545

§ 371 Date: Nov. 9, 2023

(51) Int. Cl. B64D 17/62; B64C 31/02

(52) U.S. Cl. CPC B64D 17/62; B64C 31/02

(57) ABSTRACT

The invention relates to a flight state system (20) for ascertaining a flight state of a paraglider (50, 50′) which comprises a canopy (51) with two canopy ends (52) and which carries a load (53) during intended use. Thereby, the flight state system comprises a sensor arrangement (S1, S2, S3) for ascertaining a first distance (d1) between the canopy ends (52) and/or at least a second distance (d2, d3) between a canopy end (52) and the load (53). Furthermore, the flight state system comprises an evaluation unit (37) which ascertains the flight state using the first distance (d1) and/or the second distances (d2, d3). The invention further relates to an evaluation system and/or control system (40), a paraglider (50, 50′) and a method for ascertaining a flight state of a paraglider (50, 50′).

The invention relates to a flight state system for ascertaining a flight state of a paraglider as well as an evaluation system and/or control system therefor, a paraglider with such a system and a method for ascertaining a flight state of a paraglider.

Paragliding continues to enjoy great popularity. In order to prepare new paraglider pilots before flying independently, it is recommended or, depending on the country, sometimes mandatory to complete a training course. Furthermore, it is important to be informed about the weather situation and the characteristics of the flying site in order to counteract dangerous situations. It is also important to observe rules during the flight (e.g. behavior in thermals) and certain routine procedures are prescribed for safety reasons. In spite of all these precautions, situations with increased danger potential, e.g. collapse of the canopy or the like, occur from time to time, e.g. in the case of sudden changes in wind and/or uplift conditions, mistakes by the pilot or the like. In these cases, the flight or the paraglider can often be stabilized by means of a suitable reaction and transferred to a less critical flight situation.

An inexperienced pilot sometimes misjudges these exceptional situations and, due to their rarity and/or added panic, does not know the correct way to react. In some cases, it is also difficult to assess the flight state of the respective student pilot during training, since in current training practice only the visual contact and the radio connection of the instructor from the ground or slope serve to monitor the flight situation of the respective student pilot.

It is therefore an object of the present invention to provide a system or method for ascertaining a flight state of a paraglider.

This object is solved by a flight state system according to patent claim 1, evaluation system and/or control system according to patent claim 10, a paraglider according to patent claim 11 and a method for ascertaining a flight state of a paraglider according to patent claim 12.

The aforementioned flight state system is used to ascertain a flight state of a paraglider. The paraglider comprises a canopy with two canopy ends and carries a load during intended use. The flight state system comprises a sensor arrangement for ascertaining a first distance between the canopy ends and/or at least a second distance between one canopy end and the load. In addition, the flight state system comprises an evaluation unit, which ascertains the flight state using the first distance and/or the second distances.

A paraglider is a foot-launched aerial sports device for paragliding. It includes a canopy, lines and risers. The canopy or wing is usually approximately elliptical and made of nylon fabric. It usually comprises an upper and lower sail and is divided into numerous cells extending in the direction of flight. It has two canopy ends, i.e. two wingtips, which form the lateral termination of the wing. Usually, line cascades run down from the underside of the sail in several levels, which are joined together to form a lower line cascade. The lower line cascade is in turn hooked into mallions and are connected to the respective left and right riser. In addition, a harness for the pilot is required for paragliding. The paraglider is connected to the pilot's harness via the risers, also called webbing, by means of carabiners.

This means that the load carried by the paraglider is attached to the risers by means of the carabiners. The load therefore refers to the total weight hanging from the paraglider. In addition to the pilot, the load can also include, for example, a motor and a linkage. For example, the engine can be arranged behind the pilot by means of the boom or push rods.

The flight state system comprises the components necessary to ascertain the flight state. That is, the term “flight state system” means a flight state detection system and/or a flight state prediction system as will be described in detail later. The “flight state” can typically be ascertained from the interaction of a plurality of input parameters, which according to the invention comprise the first distance and/or at least a second distance. Further parameters will be explained in detail later, they comprise for example—for one or more axes—a position, a velocity, an acceleration, an angular position, an angular velocity and/or an angular acceleration of the glider or individual components thereof, as well as for example a flight altitude, a flight altitude change, an average wind speed, a dynamic pressure in the canopy cells or the like.

The sensor arrangement comprises sensors suitable for detecting the parameters required to ascertain the flight state. For example, the ascertainment of a first distance and/or the second distance can be carried out directly by means of a distance sensor or indirectly by means of sensors which detect the inertial moments of the individual components of the paraglider in relation to each other and/or in absolute terms, i.e. e.g. one or more IMU (Inertial Measurement Unit). The sensors can thus be combined in sensor units, for example, which are arranged in particular at the canopy ends and/or in the area of the load.

A distance generally refers to the distance between two points. For example, the first distance is the distance between the two canopy ends and the second distances is the distance between one canopy end and the load.

The flight state is ascertained by means of the evaluation unit. This means that the evaluation unit combines, for example, the previously recorded values of individual input parameters into output parameters that are relevant for the pilot and characteristic of the flight state, and outputs their values. Examples of output parameters are a general flight state parameter, which combines all input parameters into a value characteristic of the current and/or future flight situation, or a stability parameter for the canopy, which indicates whether the canopy is in a stable condition or, for example, in the process of collapsing. However, depending on the application, the flight state can also be characterized by a vector of individual output parameters. In particular, when using an AI-based method for evaluating the input parameters, an abstract parameter or vector of parameters can also be ascertained as the flight state, which e.g. enables a categorization of the flight state into conventional maneuvers, aerobatic maneuvers and/or dangerous situations.

Conventional flight maneuvers are, for example: control maneuvers such as pitch, roll, “fast figure eight”, “circling in the upwind band”, descent aids such as spiral dive, “big ears” or “B-stall”. Aerobatic maneuvers are e.g. “helicopter”, “SAT” or “(infinity) tumbling”. Dangerous situations are e.g.: a complete or unilateral stall (“Stall”), an accelerated or not accelerated lateral deformation (“Flap”), a frontal deformation (“Front Stall”) as well as a permanent deformation (“Cravat”). The transition between aerobatics and dangerous situations is fluid.

The flight state is thus described by output parameters, which, compared to the input parameters, enable a faster and simpler recording and evaluation of the actual flight situation. The evaluation can be carried out by the pilot, by a flight instructor or, for example, computer-based.

Ascertaining the flight state by “using” the distances, means that other parameters can also be included in the ascertainment of the flight state, as already described above.

The invention is therefore based on the finding that in particular the ascertained distance between the canopy ends or the load and the canopy ends improves the ascertainment of the flight state. Other parameters such as the acceleration or angular acceleration of the canopy ends or a tension or force acting on the lower or upper cascade lines are disadvantageous in this respect if used solely. This is because in particular the distance of the canopy ends to each other and/or to the load are characteristic for the stability of the canopy and thus also for the general flight state.

A flight state system, in particular according to the invention, especially for a paraglider, comprises a sensor arrangement for recording flight data and an evaluation unit, which makes a prediction about a future flight state on the basis of the flight data.

The flight data includes at least the current sensor data. In addition, previous sensor data are preferably also included as flight history in order to include a development of the flight situation or the flight state. The flight data comprise, for example, completely or partially measured values for the above-mentioned input parameters. The flight state system described here for predicting a future flight state of the paraglider represents an independent idea in itself. However, special synergetic effects result when combined with the previously described flight state system. In particular, the flight state can be ascertained as described above, be encompassed by the flight data and be included in the prediction.

The prediction of the future flight state is preferably based on the experiences or assessments of experienced pilots. The evaluation unit assesses a similarity of the current flight situation in relation to example flight situations whose flight data have been previously recorded and which have been expertly assessed, e.g. with regard to their danger. The evaluation of the similarity can be done, for example, simply by comparing the parameters and their temporal course by means of the method of least squares. Preferably, however, the evaluation unit for the assessment of similarity comprises the use of a trained AI-based method, in particular a neural network, as will be described in detail later.

The evaluation system and/or control system mentioned at the beginning is suitable for use in a flight state system according to the invention. For this purpose, it has interfaces for receiving sensor data of a sensor arrangement. In particular, the sensor data comprises a first distance between canopy ends and/or at least a second distance between a canopy end and a load. Furthermore, it comprises an evaluation unit, which ascertains and/or predicts the flight state, preferably using the first distance and/or the second distances. Optionally, it further comprises a control unit that controls a motor and/or a release of a rescue parachute based on the flight state and/or a prediction.

The ascertainment and/or prediction of the flight state is essentially as already described above. Depending on the flight state and/or its prediction, the control unit generates control signals to actuate the motor and/or the release of the rescue/reserve parachute in order to mitigate a critical flight situation. For example, at the right moment a short thrust by the motor can adjust the relative speed between pilot and paraglider. This makes it possible, for example, to prevent a front collapse/front stall. This situation can occur, for example, when changing between rising and sinking air masses.

Another example is the short-term influencing of the angle of attack by appropriate control of the motor. When flying into strong thermals, a dynamic stall can occur, as the angle of attack can become critically high for a short time due to the inertia of the system. This effect can be mitigated by reducing the thrust (if necessary by a reverse thrust).

In another situation, the control unit can cause, for example, an emergency shutdown of the motor, for example, if the lines or canopy enter a safety area around the rotor. The motor can be implemented, for example, as a battery-powered electric motor with a rotor, which is used as an electric ascent aid. It is preferably located at a distance behind the pilot in the direction of flight so that the pilot cannot enter the safety area of the rotor.

Up to now, the rescue parachute (in short: reserve) is thrown manually by the pilot. However, the control device can, for example, actuate or trigger a mechanical (e.g. by means of a pre-tensioned spring) or pyro mechanical (by means of a suitable propellant) throwing device, which transports the rescuer to a sufficient distance away from the pilot. This can be particularly advantageous in a potentially confusing situation such as an uncontrolled spin, as the control unit can coordinate the timing of the release better than the pilot. This can advantageously prevent the reserve from being caught in the lines or canopy. This ensures that the reserve can perform its intended function.

The above-mentioned paraglider comprises a flight state system according to the invention and/or an evaluation system and/or control system according to the invention. Preferably, it also comprises an electrical ascent aid, which may be controlled by the control unit and/or a rescue parachute-throwing device, which may be actuated by the control unit.

The aforementioned method for ascertaining a flight state of a paraglider, which comprises a canopy with two canopy ends and which carries a load during intended operation comprises at least the following steps. A first distance between the canopy ends and/or at least a second distance between a canopy end and the load is ascertained. The flight state is ascertained using the first distance and/or the second distances. The individual features of the method are essentially analogous to the previously described device features.

The evaluation system and/or control system according to the invention, in particular also the entire flight state system, can advantageously be retrofitted in already existing paragliders. However, it is also possible to equip newly manufactured paragliders with one of the systems according to the invention during production.

The essential components of the evaluation system and/or control system according to the invention or a corresponding part of the flight state system can be predominantly designed in the form of software components. In principle, however, these components can also be partially implemented in the form of software-supported hardware, for example FPGAs or the like, in particular when particularly fast calculations are involved. Likewise, the required interfaces can be implemented as software interfaces, for example, when it is only a matter of transferring data from other software components. However, they can also be implemented as hardware interfaces that are controlled by suitable software.

In particular, the evaluation system and/or control system according to the invention can be part of a paraglider with an electric ascent aid and/or a rescue parachute that can be released by the control system.

A largely software-based implementation has the advantage that even previously used paragliders or flight state systems can be retrofitted in a simple manner by means of a software update and, if necessary, by means of fewer components in order to operate in the manner according to the invention. In this respect, the object is also solved by a corresponding computer program product with a computer program which can be loaded directly into a memory device of an evaluation system and/or control system of a paraglider, with program sections to execute all steps of the method according to the invention when the program is executed in the evaluation system and/or control system. Such a computer program product may, in addition to the computer program, possibly comprise additional components, such as documentation and/or additional components, also hardware components, such as hardware keys (dongles etc.) for using the software.

A computer-readable medium, e.g. a memory stick, a hard disk or another transportable or permanently installed data carrier, can be used for transport to the evaluation system and/or control system or to the flight state system and/or for storage thereon or therein, on which the program sections of the computer program which can be read in and executed by a computer unit of the evaluation system and/or control system or of the flight state system are stored. The computer unit may have, for example, one or more interacting microprocessors or the like for this purpose.

Further, particularly advantageous embodiments and further implementation of the invention result from the dependent claims as well as the following description, whereby the independent claims of one claim category can also be further characterized analogously to the dependent claims of another claim category and, in particular, individual features of different embodiments can also be combined to form new embodiments.

The sensor arrangement preferably comprises a number of distance sensors, which are arranged in the area of the load and/or in the area of at least one canopy end. Particularly preferably, one distance sensor is arranged in the area of the load or the pilot and at each of the two canopy ends. Particularly preferably, a distance sensor is arranged at both canopy ends as well as in the area of the load. Accordingly, the distances are preferably ascertained directly by means of the distance sensors. The distance sensors can be implemented as optical sensors, for example, but they are particularly preferably implemented as ultrasonic sensors.

Preferably, the sensor arrangement comprises one or more of the following sensors: Accelerometer, Gyroscope, Magnetometer, Barometer, GPS sensor, dynamic pressure sensor. Several of the sensors are preferably combined into sensor units. For example, accelerometers and gyroscopes may be integrated into one IMU as described above. An canopy sensor unit particularly preferably also has a distance sensor and a magnetometer in addition to such an IMU. In addition to the aforementioned sensors, a central sensor unit also comprises a barometer and a GPS sensor. In addition, load cells can preferably be added, for example, to measure the line load. These are then integrated between mallions and risers. A dynamic pressure sensor can, for example, be arranged in one of the cells of the canopy and measure the air pressure prevailing in this cell. Preferably, several dynamic pressure sensors can also be arranged in different cells in order to measure the overall pressure in the cells.

Preferably, the sensor arrangement comprises at least one LIDAR sensor. Particularly preferably, the LIDAR sensor is designed and arranged to detect the intrusion of foreign objects —e.g. lines, parts of the canopy, parts of the pilot's body-into a safety area around a rotor. When the ingress of foreign objects has been detected, the control unit may, for example, trigger an emergency shutdown of the rotor to minimize the resulting hazard. The LIDAR sensor can, for example, be assigned to the central sensor unit or also be connected separately directly to the evaluation unit.

In principle, it is possible to connect the individual components (sensors, sensor units) of the sensor arrangement with the evaluation unit or the evaluation system and/or control system or the other components of the flight state system by wire. However, the connection to the components of the sensor arrangement is preferably wireless, i.e. it is implemented for example by means of W-LAN, Bluetooth, ZigBee or similar standards for wireless transmission. In this case, the transmission of the individual measured values preferably takes place at a frequency of at least 100 Hz and at a latency of at most 10 ms.

The flight state system preferably comprises a flight recorder that stores flight data comprising a temporal sequence of flight states. Particularly preferably, the flight recorder also stores further flight data, such as the individual measured values of the sensors. On the one hand, this makes it possible for the pilot to reconstruct and train certain flight situations and reactions to them. On the other hand, the data sets generated in this way can be used to improve or train the evaluation unit, in particular an AI-based method, or the flight state system.

Preferably, the evaluation unit comprises an analysis unit with a trained AI-based method. The term AI-based method means a machine method that mimics cognitive functions related to the human mind. The term includes, for example, simple machine learning and deep machine learning. “Simple” or “traditional” machine learning methods include, for example, logistic regression, support vector machine (SVM), random forest or the like. In particular, by training based on training data, the trained AI-based method is able to adapt to new conditions and recognize and extrapolate patterns. In particular, supervised training, semi-supervised training, unsupervised training, reinforcement learning and/or active learning may be used. Further, the parameters of the trained AI-based method can be iteratively adjusted through multiple training steps.

Particularly preferably, the trained AI-based method may be a deep machine learning method, most preferably a neural network. In particular, the neural network may comprise a deep neural network, a foldable neural network or a foldable deep neural network.

The neural network has a known basic architecture. However, its inner structure is individually shaped by the training. The training thus defines the inner “structure” of the neural network and distinguishes it from other trained neural networks (even with the same basic architecture).

Within its training phase, the weights or parameters within its structure are automatically adjusted to resemble the training data. For the optimization of the weights/parameters of all layers, known optimization approaches, e.g. a gradient descent algorithm or an Adam algorithm in combination with e.g. the cross entropy loss function, can be used.

The input data (input vector) for the neural network comprise measured values of the abovementioned sensors. Depending on the application or concrete design of the neural network, either measurement data of all sensors or only the measurement data of a part of the sensors can be used. The measured values of only one point in time can be included; however, a temporal course of the measured values from a defined time interval can also be combined as an input vector.

The training data includes the input data or input vectors and associated annotations by experienced pilots. For example, the pilots can create annotations for their own flight or, for example, annotate the flight state accordingly using additionally recorded video sequences. As described above, the flight state can be annotated with regard to output parameters such as a general flight state parameter (general evaluation of the flight situation under safety aspects) e.g. using a freely selectable scale, stability parameters for the canopy e.g. using a freely selectable scale, a categorization of the flight state into defined conventional maneuvers, aerobatic maneuvers and/or defined dangerous situations or the like.

The conventional maneuvers include e.g. control maneuvers such as pitch, roll, “fast figure eight”, “circling in the upwind band”; descent aids such as spiral dive, “big ears”, “B-stall” or the like. Aerobatic maneuvers include “helicopter”, “SAT”, “(infinity) tumbling” or the like. Whereas dangerous situations include, for example, a complete or unilateral stall (“Stall”), accelerated or not accelerated lateral deformation (“Flap”), frontal deformation (“Front Stall”), permanent deformation (“Cravat”) or the like. However, the transition between aerobatic maneuver and dangerous situation can be fluid. The output vector of the neural network thus comprises all or at least part of the aforementioned output parameters and/or the categorization.

While the readings of the sensors for the training data in relation to the conventional maneuvers can also be recorded during normal paragliding, the readings of the sensors for the training data in relation to the dangerous situations can be recorded in a safe environment (e.g. over water with water rescue present) by experienced pilots by means of specifically initiated dangerous situations.

After training, the weights/parameters of the network are adapted to the specific task and can, for example, evaluate flight situations with regard to safety and/or the canopy with regard to its stability and/or recognize the current maneuvers or dangerous situations.

Based on the data described above, patterns can be recognized in the measured values of the sensors or in the input data that occur shortly before a dangerous situation. Accordingly, a prediction of a future flight state can be made, preferably using a trained AI-based method, particularly preferably using a neural network.

The individual adverse flight states, dangerous situations or their preceding patterns can be assigned typical countermeasures, such as weight shift, counter-steering, braking or the like, which help the pilot to avoid the dangerous situation and/or improve the flight state.

Accordingly, the flight state system preferably comprises acoustic and/or visual output means for outputting the flight state and/or an instruction based on the flight state and/or a prediction.

Instructions corresponding to the flight state can be issued via the output means, which contain suitable countermeasures. By means of precise instructions, e.g. the time, speed and duration of the braking impulse can be precisely adjusted to the situation. In addition to the brake lines, a shift of body weight can also be used (e.g. in case of a lateral collapse or cravat). Some situations also require the “pulling” of certain lines (e.g. stabilizer line in the case of a cravat).

The acoustic output means can include, for example, headphones and/or a loudspeaker. The optical output means can be designed, for example, as a wrist display, on a smartwatch or a smartphone with a corresponding holder. Alternatively or additionally, the optical output means can comprise AR displays (augmented reality), which display the instructions or information, e.g. in a pair of glasses or in a helmet visor as an overlay in the field of vision.

As already described above analogously in relation to the evaluation and/or control system, the flight state system preferably comprises a control unit which controls a motor and/or a release of a rescue parachute based on the flight state and/or a prediction.

The invention is explained in more detail below with reference to the attached figures using examples of embodiments. In the various figures, identical components are given identical reference numbers. The figures are generally not to scale. They show:

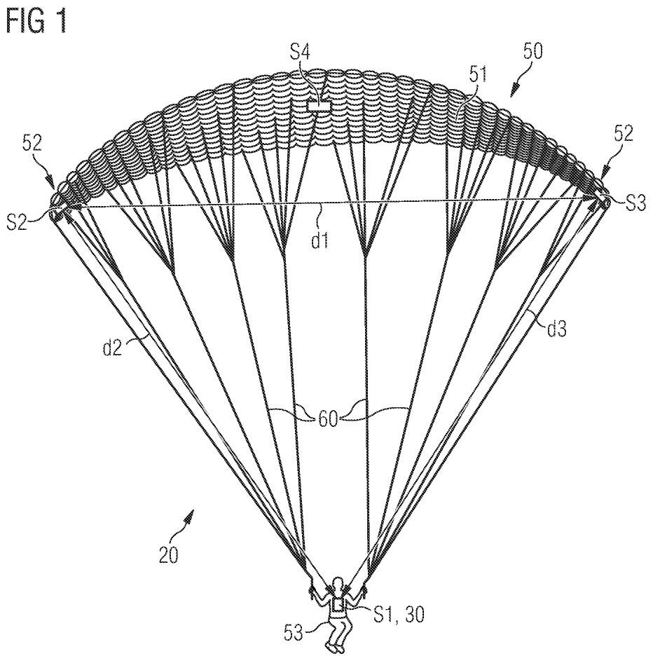

FIG. 1 roughly schematic front view of an embodiment of a paraglider according to the invention with an embodiment of a flight state system according to the invention,

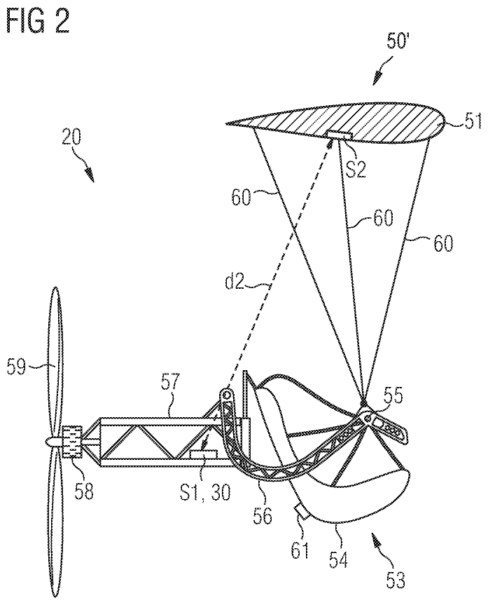

FIG. 2 roughly schematic side view of a further embodiment of a paraglider according to the invention with an embodiment of a flight state system according to the invention,

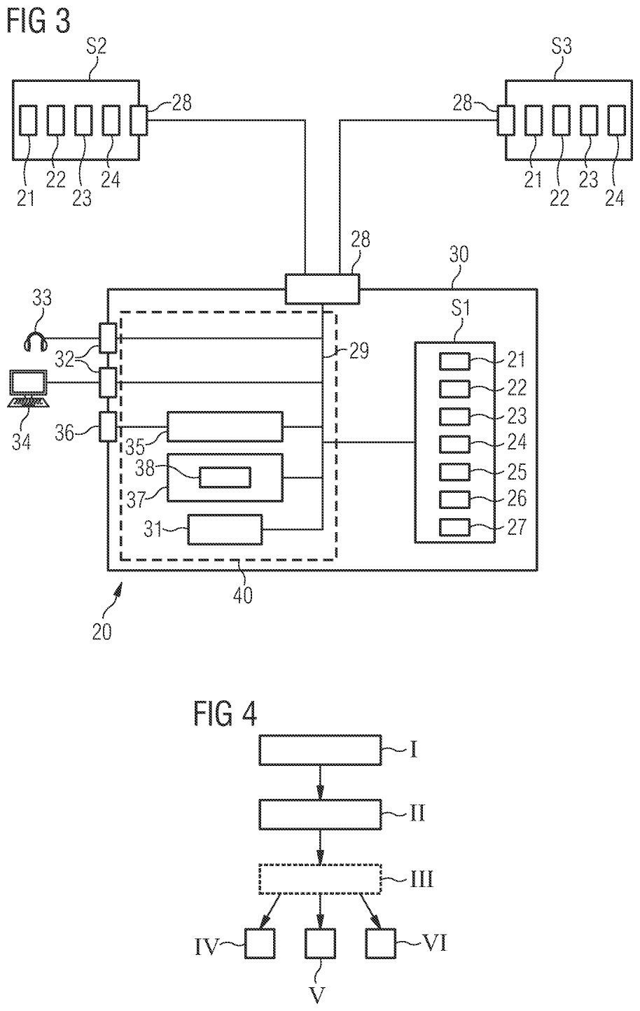

FIG. 3 schematic block diagram of an embodiment of a flight state system according to the invention,

FIG. 4 schematic flow diagram of an example of a method according to the invention for ascertaining a flight state.

FIG. 1 shows an exemplary and roughly schematic frontal view of an embodiment of a paraglider 50 according to the invention with an embodiment of a flight state system 20 according to the invention. The paraglider 50 comprises a canopy 51 connected to a load 53 by upper and lower cascade lines 60. In this embodiment example, the load is represented by a pilot 53. The canopy 51 has a substantially elliptical shape with its major axis extending perpendicular to a direction of flight. The canopy 51 has two canopy ends 52 to its lateral sides (left to right as seen by the pilot).

The flight state system 20 comprises a sensor arrangement S1, S2, S3, S4 as well as further components, such as the central unit 30, which are explained in detail with reference to FIG. 3. In this embodiment, the sensor arrangement S1, S2, S3, S4 has four sensor units S1, S2, S3, S4. A central sensor unit S1 is arranged in the area of the load or pilot 53 and can be integrated, for example, in the central unit 30. A canopy end sensor unit S2, S3 is arranged in the area of each of the canopy ends 52. In this embodiment example, a further canopy center sensor unit S4 is arranged in the area of the center of the canopy.

The canopy end sensor units S2, S3 are arranged at a first distance d1 from each other. One of the canopy end sensor units S2, S3 is arranged at a second distance d2 and d3 respectively from the load. During numerous flight maneuvers and also in dangerous situations the distances d1, d2, d3 change in a characteristic way, so that the flight maneuvers or dangerous situation can be well characterized by means of these distances. To measure the distances d1, d2, d3, the sensor units S1, S2, S3 each have an ultrasonic distance sensor 21, as explained in more detail with reference to FIG. 3.

FIG. 2 shows a roughly schematic side view of a further embodiment of an escort parachute 50′ according to the invention. The paraglider 50′ shown in FIG. 2 is fundamentally similar to the paraglider 50 in FIG. 1, but differs in that it has an electric ascent aid 58, 59. The electric ascent aid 58, 59 comprises an electric motor 58, which drives a rotor 59 to generate thrust. The electric ascent aid 58, 59 is arranged behind the pilot (not shown here) in the direction of flight and is spaced from the pilot by means of a spacer element 57 in such a way that the pilot cannot reach a safety area around the rotor 59 with his extremities. The distance element 57 is connected to the lower cascade lines 60 by means of two push rods 56 on both sides of the pilot, each at a suspension point 55, e.g. by means of a carabiner. The weight of the electric ascent aid 58, 59, the distance element 57 as well as the push rods 56 is thus also carried by the glider 50′ and contributes to the load 53.

The pilot is not shown here, but in normal operation he sits in the harness 54 and is thus also part of the load 53. A rescue parachute 61 is arranged on the harness 54, which comprises a throwing mechanism including a release, which can be controlled by means of a control unit 35, as described in detail with reference to FIG. 3. The motor 58 can also be controlled by means of the control unit 35. The control unit 35 is here an integrated part of the central unit 30. The central unit 30 is arranged at the distance element 57 and thus in the area of the load 53. The central unit 30 also comprises the central sensor unit S1 here.

FIG. 3 schematically shows a block diagram of an embodiment of a flight state system 20 according to the invention. The flight state system 20 comprises a central unit 30 located in the area of the load 53. It further comprises two peripheral canopy end sensor units S2, S3 arranged in the region of the canopy ends 52 of the glider 50, 50′. A central sensor unit S1 is integrated into the central unit 30 in this exemplary embodiment. The central sensor unit S1 and the two canopy end sensor units S2, S3 form a sensor arrangement S1, S2, S3 with the first and second distances already described with reference to FIG. 1.

The two canopy end sensor units S2, S3 are each connected to the central unit 30 by means of sensor interfaces 28. They each have a distance sensor 21, an acceleration sensor 22 and a gyroscope 23. The cropping sensor 22 or the gyroscope 23 is the accelerations in the direction of all axes and can be implemented, for example, as a combined IMU. If required, the canopy end sensor units S2, S3 can also have other sensors such as a magnetometer 24 or a dynamic pressure sensor.

Compared to the canopy end sensor units S2, S3, the central sensor unit S1 additionally comprises a barometer 25, a GPS sensor 26 and a LIDAR sensor 27, whose measuring field is aimed at the rotor 59. The LIDAR sensor 27 can thus be used to ascertain whether an object is entering the safety area of the rotor 59.

The mode of operation of the individual sensors is basically known. They serve the following purposes in detail:

The gyroscopic values of the glider 50, 50′ are ascertained in order to ascertain the rotational speed about the roll, pitch and yaw axis and to detect a deformation of the wing profile.

The acceleration values of the paraglider 50, 50′ are ascertained in order to be able to derive the movement of the paraglider or individual parts, to ascertain the horizontal orientation (vector earth gravity) as well as for the absolute long-term correction of the relative gyroscope

The long-term correction refers to the compensation of the long-term drift of the gyroscope. Since a gyroscope only records relative angular velocities, the absolute starting point must be re-ascertained at defined intervals. This is done for the roll and pitch axes by means of an adjustment to the (time-averaged) vector of the earth's gravity and for the yaw axis by means of an adjustment to the magneto-metric data.

The acceleration values of the pilot or load 53 are ascertained to establish the “synchronization” between the paraglider and the pilot, as there can be deviations in movement due to the system (pendulum), and to establish the movement vector during a take-off phase.

The gyroscopic data of the pilot or the load 53 are ascertained for the determination of the thrust vector and for the detection of disturbances during the take-off phase (e.g. tumble of the pilot during take-off).

The magneto-metric data of the paraglider and pilot are used to ascertain the difference in orientation with respect to the z-axis; since the pilot must turn 180° relative to the paraglider in the final phase of the launch when using a so-called “reverse launch” (paraglider is raised backwards, but must still be launched forwards). It is important to ascertain clearly the time of the un-twist and the beginning of the acceleration phase. The magneto-metric data from the paraglider are also used for long-term correction of the relative gyroscope.

The relative distance measurement between the wing endpoints and the pilot using ultrasound is also carried out as a long-term correction of the “integrated acceleration” or to ascertain speed and position and additionally to determine the line elongation.

Air pressure is measured to ascertain the internal dynamic pressure of the paraglider and for the detection of thermals (sinking or rising air masses).

The global positioning system (e.g. GPS, Galileo, etc.) is used for flight navigation and flight recording.

All these calculations can be performed before the corresponding results are transmitted to the neural network as input data. Alternatively, the neural network can be trained to evaluate directly the measured sensor data.

The flight state system 20 may, for example, also have one or more further sensor units, such as the canopy center sensor unit S4 (see FIG. 1), which serves as an additional (zero) reference for the long-term correction of the relative gyroscope and, if applicable, also comprises a dynamic pressure sensor in order to enable a holistic detection of the dynamic pressure distribution in the canopy.

In addition to the central sensor unit S1, the central unit 30 comprises an evaluation system and/or control system 40, which is connected to the sensor interface 28 and the central sensor unit S1 via a central bus 29 and receives data sent via it. The evaluation system and/or control system 40 has an evaluation unit 37, a control unit 35 and a flight recorder 31.

The flight recorder 31 is a writable and readable memory. It can be implemented, for example, as an SD card or micro SD card. Alternatively, it can also be implemented as a permanently installed memory that can be read out via an interface. The flight data, i.e. the measurement data of all sensors as well as ascertained flight states, are stored on the flight recorder 31.

The flight states are ascertained by the evaluation unit 37 by means of an analysis unit 38 using a neural network. The measurement data of the sensors and, if applicable, a development of these measurement data over time serve as input vector.

The neural network of the analysis unit 38 has been trained, as already described in detail above, and is therefore trained for the specific task of evaluating the flight situations with regard to safety and/or the canopy with regard to its stability and/or recognizing the momentary maneuvers and/or dangerous situations by analyzing the flight data, i.e. the measurement data of the sensors. In addition, the analysis unit 38 can predict dangerous situations based on the patterns preceding them in the flight data, as also described above.

Based on the ascertained flight state, the control unit 35 can control, for example, the motor 58 via a control interface 36. This can be used, for example, to provide additional thrust if the canopy 51 threatens to collapse, or to perform an emergency shutdown of the motor 58 if foreign objects enter the safety area of the rotor 59. The control unit 35 can also control, for example, the release for the rescue parachute 61 so that it deploys automatically in an emergency situation.

The evaluation system and/or control system 40 is also connected to acoustic output means 33 and optical output means 34 via two output interfaces 32. The acoustic output means 33 may comprise, for example, headphones and/or a loudspeaker. The optical output means 34 may, for example, be in the form of a wrist display, on a smartwatch or a smartphone with a corresponding holder. Alternatively or additionally, the optical output means can comprise AR (augmented reality) displays that show the instructions or information, e.g. in a pair of glasses or in a helmet visor as an overlay in the field of view.

Even though the components of the central unit 30 are shown here fully integrated, it is clear that the individual elements of the central unit 30 can also be designed separately at the respective interfaces if this is practical. For example, the central sensor unit S1 or the evaluation system and/or control system 40 can be implemented as separate components.

In particular, the evaluation system and/or control system 40 can be implemented essentially by means of software, as already indicated above, so that with suitable interfaces (e.g. W-LAN, radio connection, etc.) it can also be implemented, for example, on a smartphone or arranged in a ground station. In principle, the interfaces 28, 32, 36 shown and also the connection to the central sensor unit S1 can be both wired and wireless (e.g. W-LAN, Bluetooth, ZigBee, radio connection, etc.).

FIG. 4 shows a flow chart of an example of a method according to the invention for ascertaining the flight state of a paraglider 50, 50′. In a first step I, measurement data of the sensors are acquired by means of the sensor arrangement S1, S2, S3 and a first distance d1 between the canopy ends 52 as well as the two second distances d2, d3 between a canopy end 52 and the load 53 are ascertained.

In a second step II, a flight state is ascertained in the analysis unit 38 of the evaluation unit 37 by means of a neural network using the first distance d1 and/or the second distances d2, d3. I.e. the flight situation is evaluated with regard to safety and/or the canopy with regard to its stability and/or the current maneuvers and/or dangerous situations are recognized.

In a further optional step III, the analysis unit 38 makes a prediction about possible dangerous situations using the neural network based on the patterns preceding them in the flight data.

Subsequent to the ascertainment of the flight state according to step II or the prediction according to step III, the flight state and/or the prediction can be output in step IV by means of the acoustic output means 33 and/or optical output means 34. Furthermore, in step V, an instruction can be output via the acoustic output means 33 and/or optical output means 34, with the help of which the current flight state can be improved or the current dangerous situation can be terminated. Furthermore, in step VI, based on the flight state and/or the prediction, the motor 58 or the release for the rescue parachute 61 can be controlled by means of the control device.

Finally, it is pointed out once again that the devices described in detail above are merely examples of embodiments, which can be modified by the skilled person in a wide variety of ways without leaving the scope of the invention. Furthermore, the use of the indefinite articles “a” or “an” does not exclude the possibility that the features in question may be present more than once. Similarly, the terms “system”, “unit” and “arrangement” do not exclude that the component in question consists of several interacting sub-components, which may also be spatially distributed.

1. A flight state system (20) for ascertaining a flight state of a paraglider (50, 50′) comprising a canopy (51) having two canopy ends (52) and carrying a load (53) in intended use, the flight state system comprising
a sensor arrangement (S1, S2, S3) for ascertaining a first distance (d1) between the canopy ends (52) and/or at least a second distance (d2, d3) between a canopy end (52) and the load (53), and
an evaluation unit (37) which ascertains the flight state using the first distance (d1) and/or the second distances (d2, d3).

2. The flight state system according to claim 1, wherein the sensor arrangement (S1, S2, S3) comprises a number of distance sensors (21) which are arranged in an area of the load (53) and/or in the area of at least one canopy end (52).

3. The flight state system according to claim 1, wherein the sensor arrangement (S1, S2, S3) comprises one or more of the following sensors (S1, S2, S3): Accelerometer (22), Gyroscope (23), Magnetometer (24), Barometer (25), GPS sensor (26), dynamic pressure sensor.

4. The flight state system according to claim 1, wherein the sensor arrangement (S1, S2, S3) comprises at least one LIDAR sensor (27).

5. The flight state system according to claim 1, comprising a flight recorder (31) storing flight data comprising a time sequence of flight states.

6. The flight state system, in particular according to claim 1, having the sensor arrangement (S1, S2, S3) for recording flight data and the evaluation unit (37) which makes a prediction about a future flight state on the basis of the flight data.

7. The flight state system according to claim 1, wherein the evaluation unit (37) comprises an analysis unit (38) with a trained AI-based method.

8. The flight state system according to claim 1, comprising acoustic output means (33) and/or optical output means (34) for outputting the flight state and/or an instruction based on the flight state and/or a prediction.

9. The flight state system according to claim 1, comprising a control unit (35) controlling a motor (58) and/or a release of a rescue parachute (61) based on the flight state and/or a prediction.

10. An evaluation system and/or control system (40) for the flight state system according to claim 1, comprising
interfaces for receiving sensor data (28) of the sensor arrangement (S1, S2, S3), the sensor data comprising in particular the first distance (d1) between the canopy ends and/or at least the second distance (d2, d3) between the canopy end (52) and the load (53),
the evaluation unit (37) which ascertains and/or predicts the flight state, preferably using the first distance (d1) and/or the second distances (d2, d3), and
optionally a control unit (35) that controls a motor (58) and/or a release of a rescue parachute (61) based on the flight state and/or a prediction.

11. A paraglider (50, 50′) comprising the flight state system (20) according to claim 1.

12. A method of ascertaining a flight state of a paraglider (50, 50′) comprising a canopy (51) having two canopy ends (52) and carrying a load (53) in intended use, comprising at least the following steps:
ascertaining a first distance (d1) between the canopy ends (52) and/or at least a second distance (d2, d3) between a canopy end (52) and the load (53), and
ascertaining the flight state using the first distance (d1) and/or the second distances (d2, d3).

13. The method, in particular according to claim 12, comprising predicting a future flight state, preferably using a trained AI-based method.

14. A computer program product comprising a computer program directly loadable into a memory device of a flight state system (20), an evaluation system and/or a control system (40), comprising program sections to perform all steps of the method according to claim 12 when the computer program is executed in the flight state system (20), the evaluation system and/or the control system (40).

15. A computer-readable medium having stored thereon program sections readable and executable by a computer unit to perform all the steps of the method according to claim 12 when the program sections are executed by the computer unit.

16. A paraglider (50, 50′) comprising the evaluation system and/or control system (40) according to claim 10.
